(19) United States
(12) Patent Application Publication
(10) Pub. No.: US 2026/0154998 A1
(43) Pub. Date: Jun. 4, 2026

(54) VEHICLE LEAVING ASSISTANCE DEVICE

(71) Applicant: TOYOTA JIDOSHA KABUSHIKI KAISHA, Aichi (JP)

(72) Inventors: Takuya NAKAGAWA, Okazaki-shi (JP); Tomohito HIGUMA, Toyota-shi (JP); Riku HAMABE, Toyota-shi (JP)

(21) Appl. No.: 19/365,178

(22) Filed: Oct. 22, 2025

(30) Foreign Application Priority Data
Nov. 29, 2024 (JP) 2024-208305

(51) Int. Cl. G07C 5/04; B60K 35/10; B60K 35/22; B60K 35/65; B62D 1/04; G10L 15/22

(52) U.S. Cl. CPC G07C 5/04; B60K 35/10; B60K 35/22; B60K 35/654; B62D 1/046; G10L 15/22; G10L 2015/223

(57) ABSTRACT

A vehicle leaving assistance device comprising: a surrounding information acquisition device that acquires information about surroundings of a vehicle; and an electronic control unit that is configured to execute registration of a leaving route of the vehicle by storing the leaving route of the vehicle in a storage device when a leaving start switch is operated by a driver in a situation where the vehicle leaves a parking lot and runs by driving operation of the driver, and to terminate the registration of the leaving route of the vehicle when a registration termination switch is operated by the driver. The registration termination switch includes a switch that can be operated by the driver while the vehicle is running.

### CROSS-REFERENCE TO RELATED APPLICATION

This application claims priority to Japanese Patent Application No. JP2024-208305 filed on Nov. 29, 2024, the content of which is hereby incorporated by reference in its entirety into this application.

### BACKGROUND

### 1. Technical Field

The present disclosure relates to an assistance device for assisting leaving from a parking space for a vehicle such as an automobile.

### 2. Description of the Related Art

In vehicles such as automobiles, an assistance device for assisting leaving from a parking space is known which stores a running route of a vehicle when leaving from a parking space by driving of a driver in a storage device and automatically moves the vehicle along the route stored in the storage device as a target route when the vehicle leaves from the parking space. For example, Japanese Patent Application Laid-open Publication No. 2023-63070 describes a parking assistance device that registers when a vehicle is moved from a parking lot to a temporary stopping position by driving of a driver, the parking lot, a running route of the vehicle from the parking lot to the temporary stopping position, and the temporary stopping position. The registration of the route for leaving the parking lot is completed when the vehicle stops and a shift position is confirmed to be in P position.

In a conventional leaving assistance device such as the leaving assistance device described in the above-mentioned Japanese Patent Application Laid-open Publication, registration of a leaving route and the like is completed when a vehicle stops and it is confirmed that a shift position is in P position. Therefore, in order to complete registration of the leaving route and the like, it is necessary to stop the vehicle, and it is not possible to complete registration of the leaving route and the like without stopping the vehicle.

### SUMMARY

The present disclosure provides a vehicle leaving assistance device that registers a leaving route taken by a vehicle when the vehicle leaves a parking lot by driving of a driver as a leaving route and is improved so that registration of the leaving route can be completed without stopping the vehicle.

According to the present disclosure, a vehicle leaving assistance device is provided that comprises: a surrounding information acquisition device that acquires information about surroundings of a vehicle; and an electronic control unit that is configured to execute registration of a leaving route of the vehicle by storing the leaving route of the vehicle in a storage device when a leaving start switch is operated by a driver in a situation where the vehicle leaves a parking lot and runs by driving operation of the driver, and to terminate the registration of the leaving route of the vehicle when a registration termination switch is operated by the driver.

Furthermore, according to the present disclosure, the registration termination switch includes a switch that can be operated by the driver while the vehicle is running.

According to the above configuration, when the registration termination switch is operated by the driver, the registration of the leaving route of the vehicle is terminated, and the registration termination switch includes a switch that can be operated by the driver while the vehicle is running. Therefore, by operating the switch that can be operated while the vehicle is running, the driver can terminate the registration of the leaving route of the vehicle without stopping the vehicle.

In one aspect of the present disclosure, the registration termination switch includes a first registration termination switch that can be operated by the driver with his/her hand removed from a steering wheel, and a second registration termination switch that can be operated by the driver without removing his/her hand from the steering wheel while the vehicle is running, and the electronic control unit is configured to enable operation of the second registration termination switch without enabling operation of the first registration termination switch when the vehicle is running, and to enable operation of both the first and second registration termination switches when the vehicle is stopped.

According to the above aspect, when the vehicle is running, only the second registration termination switch can be operated, and when the vehicle is stopped, both the first and second registration termination switches can be operated. Therefore, when the vehicle is running, the driver can terminate the registration of the leaving route of the vehicle by operating the second registration termination switch. In addition, when the vehicle is stopped, the driver can terminate the registration of the leaving route of the vehicle by operating the first registration termination switch or the second registration termination switch.

In another aspect of the present disclosure the electronic control unit is configured to start registration of the leaving route of the vehicle and to notify the driver that the second registration termination switch can be operated when the registration start switch is operated by the driver.

According to the above aspect, when the registration start switch is operated by the driver, registration of the leaving route of the vehicle starts, and the driver is notified that the second registration termination switch can be operated. Therefore, the driver can recognize that registration of the leaving route of the vehicle is in progress and that the second registration termination switch can be operated.

In another aspect of the present disclosure, the first registration termination switch is a soft switch displayed on a display device that is visible to the driver, and the second registration termination switch is a switch provided on the steering wheel.

According to the above aspect, since the first registration termination switch is a soft switch displayed on a display device that is visible to the driver, the driver can operate the first registration termination switch by operating the soft switch displayed on the display device. In addition, since the second registration termination switch is a switch provided on the steering wheel, the driver can operate the second registration termination switch without removing his/her hand from the steering wheel.

In another aspect of the present disclosure, the first registration termination switch is a soft switch displayed on a display device that is visible to the driver, and the second registration termination switch is a switch operated by a voice command.

According to the above aspect, since the first registration termination switch is a soft switch displayed on a display device that is visible to the driver, the driver can operate the first registration termination switch by operating the soft switch displayed on the display device. In addition, since the second registration termination switch is a switch operated by a voice command, the driver can operate the second registration termination switch by the voice command without removing his/her hand from the steering wheel.

In yet another aspect of the present disclosure, the electronic control unit is configured not to display the soft switch on the display device in a state operable by the driver while the vehicle is running after starting the registration of the leaving route of the vehicle.

According to the above aspect, the soft switch is not displayed on the display device in an operable state while the vehicle is running after starting the registration of the leaving route of the vehicle. Thus, the driver can be prevented from operating the soft switch while the vehicle is running.

In another aspect of the present disclosure, the electronic control unit is configured to display the soft switch on the display device when the vehicle is stopped after starting the registration of the leaving route of the vehicle.

According to the above aspect, the soft switch is displayed on the display device when the vehicle is stopped after starting the registration of the leaving route of the vehicle. Thus, the driver can operate the soft switch when the vehicle is stopped.

In another aspect of the present disclosure, the electronic control unit is configured to terminate the registration of the leaving route of the vehicle even though the second registration termination switch is not operated by the driver when the electronic control unit determines that the vehicle has traveled a distance equal to or greater than a reference distance without stopping after starting the registration of the leaving route of the vehicle.

According to the above aspect, when the vehicle has traveled a distance equal to or greater than the reference distance without stopping after starting the registration of the leaving route of the vehicle, the registration of the leaving route of the vehicle is terminated even though the second registration termination switch is not operated by the driver. Therefore, the driver can terminate the registration of the leaving route of the vehicle without operating the second registration termination switch, thereby preventing the registration of the leaving route of the vehicle from continuing unnecessarily for a long time.

In another aspect of the present disclosure, the registration start switch includes a first registration start switch that is operated by the driver with his/her hand removed from the steering wheel, and a second registration start switch that can be operated by the driver without removing his/her hand from the steering wheel, and the electronic control unit is configured to enable operation of at least one of the first and second registration start switches while the vehicle is stopped.

According to the above aspect, when the vehicle is stopped, it is possible to operate at least one of the first registration start switch that is operated by a hand removed from the steering wheel and the second registration start switch that can be operated without removing the hand from the steering wheel. Therefore, the driver can start registration of the leaving route of the vehicle by operating at least one of the first and second registration start switches.

In another aspect of the present disclosure, the first registration start switch is a soft switch displayed on a display device that is visible to the driver, and the second registration start switch is a switch provided on the steering wheel.

According to the above aspect, since the first registration start switch is a soft switch displayed on a display device that is visible to the driver, the driver can operate the first registration start switch by operating the soft switch displayed on the display device. In addition, since the second registration start switch is a switch provided on the steering wheel, the driver can operate the second registration start switch without removing his/her hand from the steering wheel.

In another aspect of the present disclosure, the first registration start switch is a soft switch displayed on a display device that is visible to the driver, and the second registration start switch is a switch operated by a voice command.

According to the above aspect, since the first registration start switch is a soft switch displayed on a display device that is visible to the driver, the driver can operate the first registration start switch by operating the soft switch displayed on the display device. In addition, since the second registration start switch is a switch operated by a voice command, the driver can operate the second registration start switch by the voice command without removing his/her hand from the steering wheel.

Other objects, other features and attendant advantages of the present disclosure will be readily understood from the description of an embodiment of the present disclosure described with reference to the following drawings.

### BRIEF DESCRIPTION OF THE DRAWINGS

FIG. 1 is a schematic configuration diagram showing a leaving assistance device according to the embodiment of the disclosure.

FIG. 2 is a view showing an interior of a vehicle equipped with the leaving assistance device.

FIG. 3 is a flowchart showing a leaving route registration control routine in the embodiment.

FIGS. 4A, 4B and 4C are bird's-eye views for explaining a control of leaving route registration in a case where a vehicle stops once in front of the home.

FIGS. 5A, 5B and 5C are bird's-eye views for explaining the control of leaving route registration in a case where the registration termination switch is operated without the vehicle stopping in front of the home.

FIGS. 6A, 6B and 6C are bird's-eye views for explaining the control of leaving route registration in a case where the vehicle does not stop in front of the home and the registration termination switch is not operated.

### DETAILED DESCRIPTION

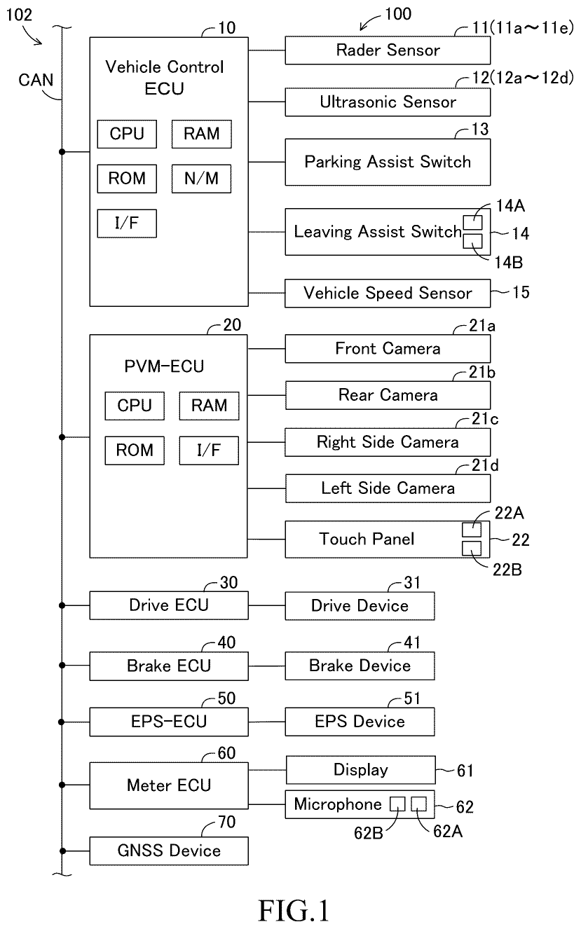

As shown in FIG. 1, the leaving assistance device according to the embodiment of the present disclosure is configured as a parking leaving assistance device 100 applied to a vehicle 102. The parking leaving assistance device 100 is equipped with a vehicle control ECU 10, a PVM (Panoramic View Monitor)-ECU 20, a drive ECU 30, a brake ECU 40, an EPS-ECU 50, a meter ECU 60, and a GNS device 70. Note that an ECU is an electronic control unit primarily comprising a microcomputer, and the vehicle control ECU 10 is also referred to as a “VC-ECU.”

A microcomputer of each ECU includes a CPU, ROM, RAM, a read/write-enabled non-volatile memory (N/M), an interface (I/F), and the like. The CPU executes instructions (programs, routines) stored in the ROM to perform various functions. Furthermore, these ECUs are interconnected via a CAN (Controller Area Network) to enable data exchange (communication) between them. Therefore, detected values from sensors (including switches) connected to a specific ECU are transmitted to other ECUs.

The VC-ECU 10 is connected to a plurality of radar sensors 11a to 11e, a plurality of ultrasonic sensors 12a to 12d, a parking assist switch 13, a leaving assist switch 14, and a vehicle speed sensor 15. Note that the multiple radar sensors 11a to 11e are referred to as “radar sensor 11” when there is no need to distinguish them. The multiple ultrasonic sensors 12a to 12d are referred to as “ultrasonic sensor 12” when there is no need to distinguish them.

The radar sensor 11 is a well-known sensor that utilizes millimeter-wave radio waves (hereinafter referred to as “millimeter waves”). The radar sensor 11 acquires target information such as a distance between the vehicle 102 and a three-dimensional object, a relative velocity between the vehicle 102 and the object, and a relative position (direction) of the object with respect to the vehicle 102, and outputs the target information to the VC-ECU 10. The radar sensor 11 is not limited to four.

Although not shown in the figure, radar sensors 11a to 11e are arranged at a right corner of a front end, a center of the front end, a left corner of the front end, a right corner of a rear end, and a left corner of the rear end of the vehicle 102, respectively. The radar sensors 11a to 11c acquire target information of three-dimensional objects existing in a right front area, a front area, and a left front area relative to the vehicle 102, respectively. The radar sensors 11d and 11e acquire target information of three-dimensional objects existing in a right rear area and a left rear area relative to the vehicle 102, respectively.

The ultrasonic sensor 12 is a well-known sensor that uses ultrasonic waves. The ultrasonic sensor 12 transmits ultrasonic waves within a predetermined range, receives reflected waves reflected by three-dimensional objects, and detects presence or absence of three-dimensional objects and distances to the three-dimensional objects based on time between the transmission and reception of the ultrasonic waves. Note that the ultrasonic sensor 12 is not limited to four.

The ultrasonic sensors 12a to 12d acquire distances between three-dimensional objects existing in the following detection areas and the ultrasonic sensors, and transmit information regarding the distances to the VC-ECU 10. The detection area of the ultrasonic sensor 12a is an area to the right front of the vehicle 102, and the detection area of the ultrasonic sensor 12b is an area to the left front of the vehicle 102. The detection area of the ultrasonic sensor 12c is an area to the rear right of the vehicle 102, and the detection area of the ultrasonic sensor 12d is an area to the rear left of the vehicle 102.

The parking assist switch 13 and the leaving assist switch 14 are
control and a leaving assist control, respectively. Although not shown in the figure, the parking assist switch 13 includes a parking registration switch and a parking control switch, and the leaving assist switch 14 includes a leaving registration switch and a leaving control switch. The vehicle speed sensor 15 detects a speed of the vehicle 102 by detecting a wheel speed and outputs a signal representing the vehicle speed.

The PVM-ECU 20 is connected to imaging devices including a front camera 21a, a rear camera 21b, a right side camera 21c, and a left side camera 21d. Note that the front camera 21a, rear camera 21b, right side camera 21c, and left side camera 21d are collectively referred to as “camera 21” when there is no need to distinguish them.

Although not shown in detail in the figure, the front camera 21a is provided at approximately the center of a front bumper across the vehicle width and images a front of the vehicle 102. The rear camera 21b is provided on a rear trunk wall of the vehicle 102 and images a rear of the vehicle 102.

The right side camera 21c is mounted on a right door mirror and captures a right side of the vehicle 102. The left side camera 21d is mounted on a left door mirror and captures a left side of the vehicle 102.

A field of view of the camera 21 is wide-angle. Therefore, an imaging range of the camera 21 includes the areas to the right, left, below, and above an optical axis, centered on the optical axis. The four cameras 21a, 21b, 21c and 21d cooperate with each other to image the entire surroundings of the vehicle 102. The camera 21 acquires image information (image data) by imaging the surrounding areas of the vehicle 102 corresponding to the imaging ranges at regular intervals. The camera 21 transmits the acquired image data to the PVM-ECU 20 and the VC-ECU 10. The Camera 21 functions as a surrounding information acquisition device that collaborates with the radar sensor 11 and the ultrasonic sensor 12 to acquire information about the surroundings of the vehicle 102.

The PVM-ECU 20 generates peripheral image data at predetermined intervals using the front image data, rear image data, right side image data, and left side image data transmitted from the front camera 21a, rear camera 21b, right side camera 21c, and left side camera 21d, respectively.

The PVM-ECU 20 generates front bird's-eye view image data, rear bird's-eye view image data, right bird's-eye view image data, left bird's-eye view image data, and all-around bird's-eye view image data at predetermined time intervals using the front image data, rear image data, right side image data, and left side image data. The images generated based on the front bird's-eye view image data, rear bird's-eye view image data, right bird's-eye view image data, left bird's-eye view image data, and all-around bird's-eye view image data are referred to as the front bird's-eye view image, rear bird's-eye view image, right bird's-eye view image, left bird's-eye view image, and all-around bird's-eye view image, respectively. Note that the front bird's-eye view image, rear bird's-eye view image, right bird's-eye view image, left bird's-eye view image, and all-around bird's-eye view image may be referred to as “bird's-eye view images” as needed.

The VC-ECU 10 is configured to acquire the bird's-eye view images from the PVM-ECU 20 at predetermined intervals and to analyze the bird's-eye view images at predetermined timings to extract feature points. As is well known, when extracting feature points, the VC-ECU 10 divides an imaging range of each bird's-eye view image into multiple divided areas and extracts a predetermined number of feature points for each divided area. The feature points are square-shaped images that include areas with relatively large changes in brightness (particularly corners and curved areas).

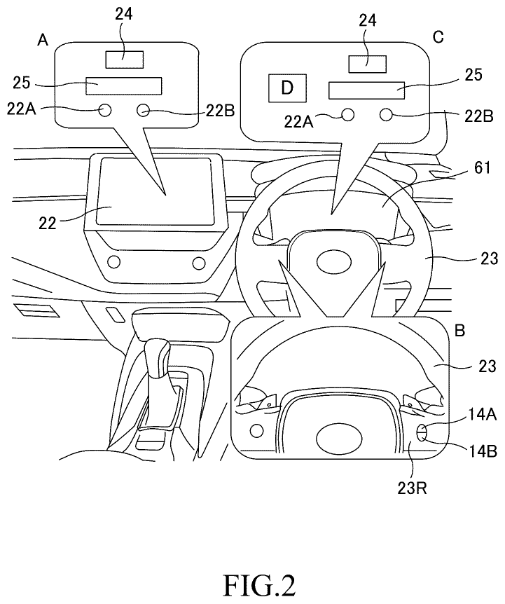

The PVM-ECU 20 is further connected to a touch panel 22. The touch panel 22 is a touch panel-type display provided by the GNSS device 70. The PVM-ECU 20 displays surrounding images and the like on the touch panel 22 in accordance with commands sent from the VC-ECU 10, and, although not shown in FIG. 1, displays the parking assist switch 13 and the leaving assist switch 14 as soft switches when the vehicle 102 is stopped. These switches are operated by the driver touching the touch panel 22 with fingers that are not holding a steering wheel 23 (see FIG. 2).

When a leaving registration switch of the leaving assist switch 14 is touched, a first registration start switch 22A and a first registration termination switch 22B are displayed as soft switches on the touch panel 22, as shown in FIG. 1 and in a bubble A in FIG. 2. In addition, as shown in a bubble B in FIG. 2, the leaving registration switch of the leaving assistance switch 14 includes a second registration start switch 14A and a second registration termination switch 14B provided on a spoke portion 23R of the steering wheel 23. These switches are steering switches that are operated without the driver removing his hands from the steering wheel 23. The first registration termination switch 22B may be displayed on the touch panel 22 while the vehicle 102 is stopped, and may not be displayed on the touch panel 22 in a condition where the driver is able to operate the switch while the vehicle 102 is running.

In this embodiment, the VC-ECU 10 is configured to execute a parking assistance control and a leaving assistance control. The parking assistance control includes two types of assistance modes: parking route registration control and parking driving assistance control. The leaving assistance control includes two types of assistance modes: leaving route registration control and leaving driving assistance control. The leaving route registration control is started when the first registration start switch 22A or the second registration start switch 14A is operated, and is terminated when the first registration termination switch 22B or the second registration termination switch 14B is operated.

The drive ECU 30 is connected to a drive device 31 that includes a drive source such as an engine, which is not shown in the figure. The drive ECU 30 changes a drive torque generated by the drive device 31. The drive torque generated by the drive device 31 is transmitted to drive wheels, which are not shown in the figure.

Therefore, the drive ECU 30 can control a driving force of the vehicle 102 by controlling the drive device 31. The VC-ECU 10 can send a drive command to the drive ECU 30. When the drive ECU 30 receives the drive command, it controls the drive device 31 in accordance with the drive command. Therefore, the VC-ECU 10 can automatically control the driving force of the vehicle 102 through the drive ECU 30.

The drive device 31 may be any drive device known in the art, such as an engine and transmission, a combination of an engine and a motor or motors (so-called hybrid system), a combination of a fuel cell and a motor or motors, or a motor or motors.

The brake ECU 40 is connected to a brake device 41 that decelerates the vehicle 102 by applying braking force to wheels. The brake ECU 40 normally controls the brake device to vary the braking force generated by the brake device 41 in response to a braking operation of the driver. When it receives a command signal from the VC-ECU 10, it controls the brake device 41 based on the command signal to perform automatic braking.

Therefore, the brake ECU 40 can control a braking force of the vehicle 102 by controlling the brake device 41. The VC-ECU 10 can send a brake command to the brake ECU 40. When the brake ECU 40 receives the brake command, it controls the brake device 41 in accordance with the brake command. Therefore, the VC-ECU 10 can perform automatic control of the braking force of the vehicle 102 via the brake ECU 40.

The EPS-ECU 50 is connected to an EPS device 51 and a steering angle sensor and a steering torque sensor not shown in FIG. 1. The EPS-ECU 50 controls a steering assist torque by controlling the EPS device 51 in accordance with a steering torque and a vehicle speed detected by a steering angle sensor and the vehicle speed sensor 15, respectively, thereby reducing steering load of the driver. Additionally, the EPS-ECU 50 can steer steering wheels (not shown) as needed by controlling the EPS device 51.

The VC-ECU 10 sends steering commands to the EPS-ECU 50 as needed. When the EPS-ECU 50 receives a steering command, it drives the EPS device 51 based on the received steering command. Therefore, the VC-ECU 10 can automatically change a steering angle of the steering wheels of the vehicle 102 through the EPS-ECU 50 without requiring steering operation by the driver. In other words, the VC-ECU 10 can perform automatic control of the steering angle of the steering wheels through the EPS-ECU 50.

The meter ECU 60 is connected to a display 61. The display 61 is a multi-information display located in front of a driver's seat. The display 61 displays various information in addition to measured values such as the vehicle speed and an engine rotation speed.

The GNSS device 70 receives radio waves emitted by positioning satellites and sequentially measures a current position of the vehicle 102 (specifically, longitude and latitude) based on received radio waves. The GNSS device 70 then sequentially transmits the measured current position of the vehicle 102 to the VC-ECU 10. Note that the GNSS device 70 may be replaced with a GPS device.

As described above, the parking assistance control includes two control modes, namely, the parking route registration control and the parking driving assistance control, and the leaving assistance control includes two control modes, namely, the leaving route registration control and the leaving driving assistance control. The mode is selected by operating the parking assistance switch 13 and the leaving assistance switch 14.

The present disclosure relates to the leaving route registration control, which will be described in detail below. The parking route registration control, the parking driving assistance control, and the leaving driving assistance control may be performed in any manner known in the art.

As will be explained in detail later, in the leaving route registration control, information on characteristic points around the vehicle 102 that change as the vehicle moves is linked to information on the position of the vehicle to identify a leaving route, and the leaving route is temporarily stored in the RAM of the VC-ECU 10 in sequence. Furthermore, when the first registration termination switch 22B or the second registration termination switch 14B is operated, the leaving route is stored in the non-volatile memory of the VC-ECU 10, and the registration of the leaving route is completed. The identification and registration of the leaving route may also be performed by any method known in the art.

### Leaving Route Registration Control

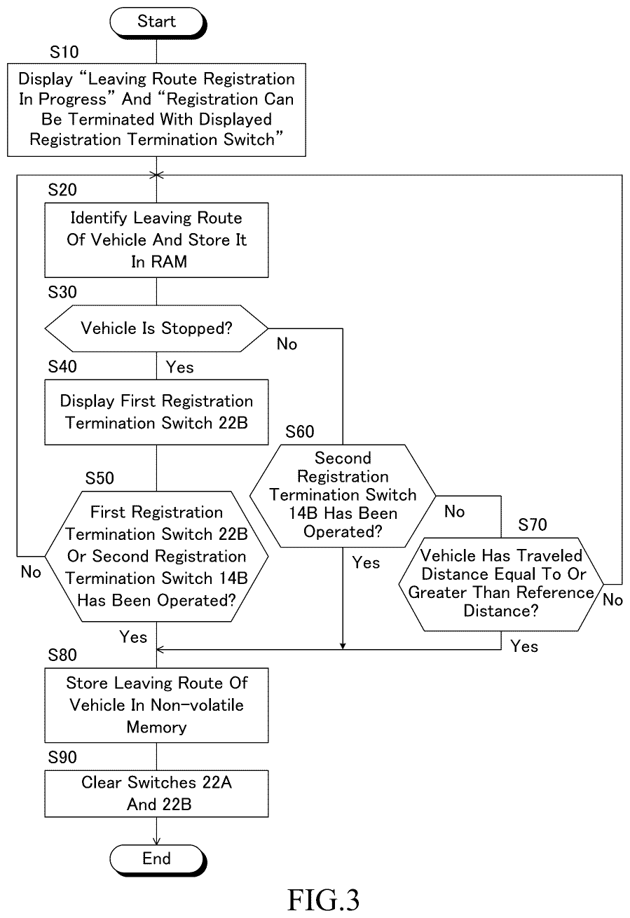

Next, the leaving route registration control routine in the embodiment will be described with reference to the flowchart shown in FIG. 3. The control according to the flowchart shown in FIG. 3 is started by the CPU of the VC-ECU 10 when the first registration start switch 22A or the second registration start switch 14A is operated while the leaving assistance switch 14 is turned on, and is repeatedly executed at predetermined intervals.

First, in step S10, the CPU outputs a command signal to the PVM-ECU 20, and a message 24 such as “Leaving route registration in progress” and a message 25 such as “Registration can be terminated with displayed registration termination switch” are displayed on the touch panel 22. As shown in the bubble A in FIG. 2, the touch panel 22 also displays a first registration start switch 22A and a first registration termination switch 22B. As shown in a bubble C in FIG. 2, the messages 24 and 25 and the switches 22A and 22B may also be displayed on the display 61.

In step S20, the CPU acquires a bird's-eye view image from the PVM-ECU 20 and extracts feature points by analyzing the bird's-eye view image. The CPU also identifies the current position of the vehicle 102 as the relative position with respect to the surrounding information based on the feature points, thereby identifying a leaving route of the vehicle and storing it in the RAM. When step S20 is executed immediately after step S10 is executed, a current position and direction of the vehicle 102 detected by the GNS device 70 are acquired, and this information may be used to identify the leaving route of the vehicle.

In step S30, the CPU determines whether the vehicle 102 is stopped based on the vehicle speed V detected by, for example, the vehicle speed sensor 15. When a negative determination is made, the control proceeds to step S60, and when an affirmative determination is made, the control proceeds to step S40.

In step S40, the CPU outputs a command signal to the PVM-ECU 20 to display the first registration termination switch 22B, which functions as a soft switch, on the touch panel 22.

In step S50, the CPU determines whether the first registration termination switch 22B displayed on the touch panel 22 or the second registration termination switch 14B, which is a steering switch, has been operated by the driver. When a negative determination is made, the control returns to step S20, and when an affirmative determination is made, the control proceeds to step S80.

In step S60, the CPU determines whether the second registration termination switch 14B, which is a steering switch, has been operated by the driver. When an affirmative determination is made, the control proceeds to step S80, and when a negative determination is made, the control proceeds to step S70.

In step S70, the CPU determines whether the vehicle 102 has traveled a distance equal to or greater than a reference distance after step S10 has been executed. When a negative determination is made, the control returns to step S20, and when an affirmative determination is made, the control proceeds to step S80.

In step S80, the CPU stores the leaving route of the vehicle 102 stored in the RAM in step S20 in the non-volatile memory as the leaving route from the start of leaving to the present.

In step S90, the CPU outputs a command signal to the PVM-ECU 20 to clear the messages 23 and 24 displayed on the touch panel 22, as well as the first registration start switch 22A and the first registration termination switch 22B. If the messages 23, 24, and switches 22A and 22B are also displayed on the display 61, the display on the display 61 is also cleared.

### Examples of the Control

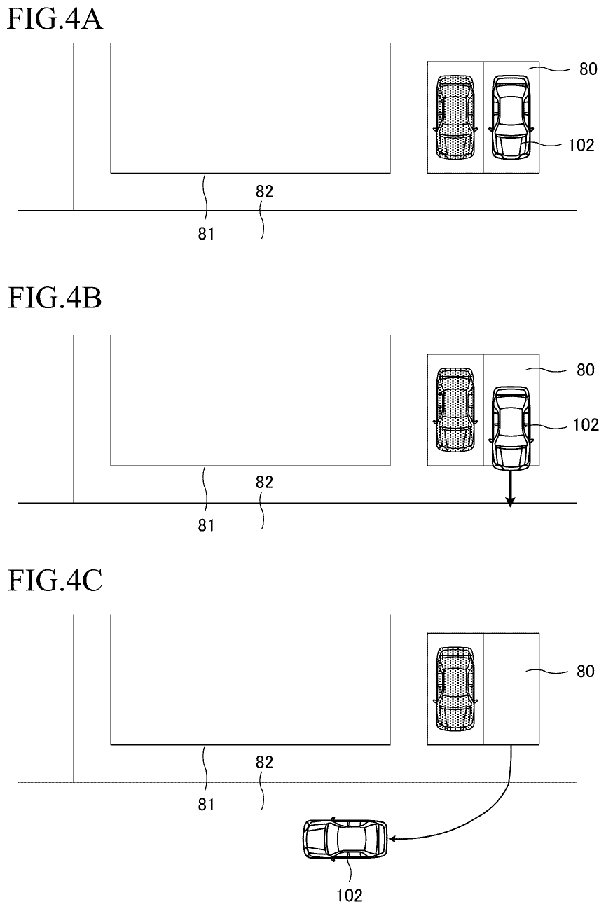

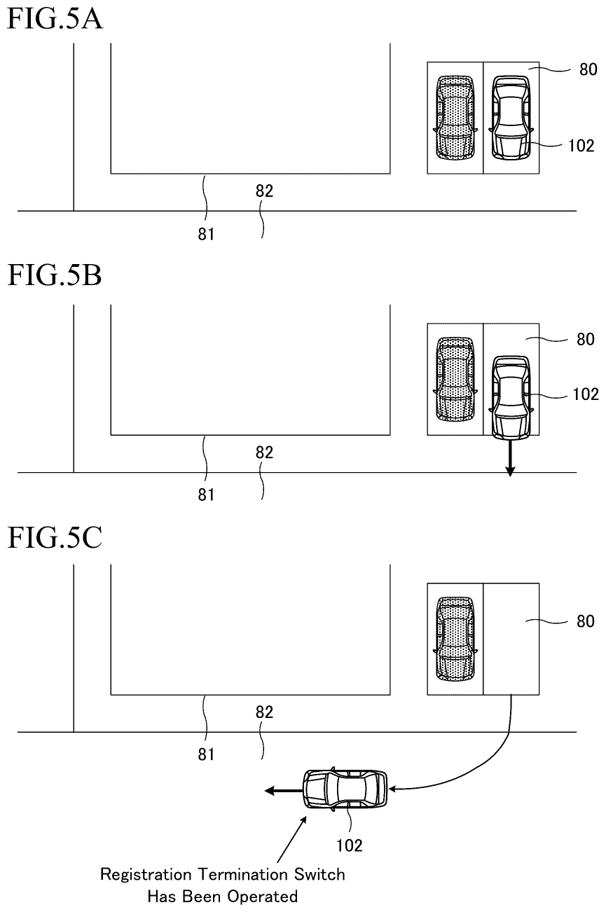

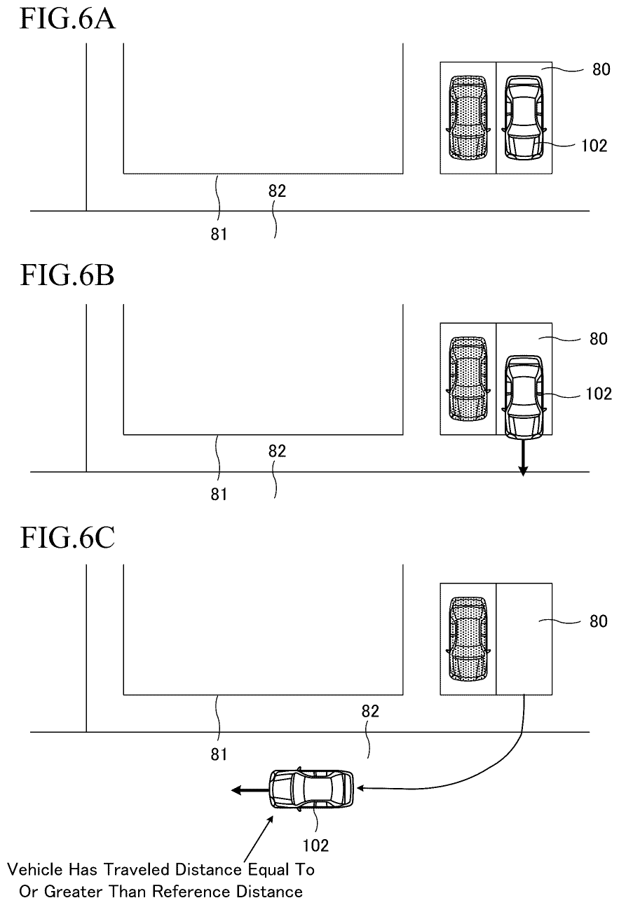

FIGS. 4A to 4C, FIGS. 5A to 5C and FIGS. 6A to 6C are bird's-eye views explaining the control of leaving route registration when the driver moves a parked vehicle 102 from a parking lot 80 to a road 82 in front of his/her home 81. In particular, FIGS. 4A, 4B and 4C show a case where the vehicle 102 stops temporarily in front of the home 81. FIGS. 5A, 5B and 5C show a case where the registration termination switch is operated without the vehicle 102 stopping in front of the home 81. FIGS. 6A, 6B and 6C show a case where the vehicle 102 does not stop in front of the home 81 and the registration termination switch is not operated.

In the case of FIGS. 4A, 4B and 4C, when the vehicle 102 stops temporarily in front of the home 81, an affirmative determination is made in step S30, and in step S40, the first registration termination switch 22B is displayed on the touch panel 22. When the first registration termination switch 22B or the second registration termination switch 14B, which is a steering switch, is operated by the driver, an affirmative determination is made in step S50. As a result, in step S80, a leaving route of the vehicle 102 stored in the RAM is stored in the non-volatile memory as the leaving route from the start of leaving to the present, and the registration of the leaving route is completed.

In the case of FIGS. 5A, 5B and 5C, since the vehicle 102 does not stop, a negative determination is made in step S30. In step S60, when it is determined that the second registration termination switch 14B, which is a steering switch, is operated by the driver, the leaving route of vehicle 102 stored in the RAM is stored in the non-volatile memory as the leaving route in step S80, and the registration of the leaving route is completed.

In the case of FIGS. 6A, 6B and 6C, since the vehicle 102 does not stop, a negative determination is made in step S30. Furthermore, since the registration termination switch 14B is not operated, a negative determination is made in step S60. When a travel distance after the vehicle 102 has started leaving the parking lot becomes equal to or greater than the reference distance, an affirmative determination is made in step S70. Therefore, in step S80, the leaving route of the vehicle 102 stored in the RAM is stored in the non-volatile memory as the leaving route, and the registration of the leaving route is completed.

In the leaving assistance control, the vehicle is controlled so that it automatically moves along the leaving route registered by the leaving route registration control or a target leaving route based on the registered leaving route. When there are a plurality of leaving routes registered or target leaving routes based on the registered leaving routes, they may be displayed on the display device 22, for example, and be selected by touch.

As can be understood from the above description, according to the above embodiment, when the registration termination switch 14A or 22A is operated by the driver, the registration of the leaving route of the vehicle 102 is terminated, and the registration termination switch includes a switch 22A that can be operated while the vehicle is running. Therefore, by operating the switch that can be operated by the driver while the vehicle is running, the driver can complete the registration of the leaving route of the vehicle without stopping the vehicle.

In addition, according to the above embodiment, when the vehicle 102 is running, only the second registration termination switch 14B can be operated, and when the vehicle is stopped, both the first registration termination switch 22B and the second registration termination switch 14B can be operated. Therefore, when the vehicle is running, the driver can terminate the registration of the leaving route of the vehicle by operating the second registration termination switch. In addition, when the vehicle is stopped, the driver can terminate the registration of the leaving route of the vehicle by operating the first registration termination switch or the second registration termination switch.

Furthermore, according to the above embodiment, when the registration start switch 14A or 22A is operated by the driver, the registration of a leaving route of the vehicle 102 starts, and the driver is notified that the second registration termination switch 14B can be operated. Therefore, the driver can recognize that the registration of the leaving route of the vehicle is in progress and that the second registration termination switch can be operated.

Furthermore, according to the above embodiment, since the first registration termination switch is a soft switch 22B displayed on the display device 22 that is visible to the driver, the driver can operate the first registration termination switch by operating the soft switch displayed on the display device 22. In addition, since the second registration termination switch is a switch 14B provided on the steering wheel 23, the driver can operate the second registration termination switch without removing his/her hand from the steering wheel.

Furthermore, according to the above embodiment, the soft switch is not displayed in a state operable on the display device 22 while the vehicle is running after starting registration of the leaving route of the vehicle 102. Thus, the driver can be prevented from operating the soft switch while the vehicle is running.

Furthermore, according to the above embodiment, the soft switch is displayed on the display device 22 when the vehicle 102 is stopped after starting the registration of the leaving route. Thus, the driver can operate the soft switch while the vehicle is stopped.

Furthermore, according to the above embodiment, when the vehicle 102 has traveled a distance greater than the reference distance without stopping after starting the registration of the leaving route of the vehicle 102, the registration of the leaving route of the vehicle is terminated even though the second registration termination switch 14B is not operated by the driver. Therefore, the driver can complete the registration of the leaving route of the vehicle without operating the second registration termination switch, thereby preventing the registration of the leaving route of the vehicle from continuing unnecessarily for a long time.

Furthermore, according to the above embodiment, when the vehicle 102 is stopped, it is possible to operate at least one of a first registration start switch 22A that is operated by a hand removed from the steering wheel 23 and the second registration start switch 14A that can be operated without releasing the hand from the steering wheel. Therefore, the driver can start registration of the leaving route of the vehicle by operating at least one of the first and second registration start switches.

Furthermore, according to the above embodiment, the first registration start switch is a soft switch 22A displayed on the display device 22 that is visible to the driver, so that the driver can operate the first registration start switch by operating the soft switch displayed on the display device. In addition, the second registration start switch is a switch 14A provided on the steering wheel 23, so that the driver can operate the second registration start switch without removing his/her hand from the steering wheel.

Although the present disclosure has been described in detail with reference to the specific embodiment, it will be apparent to those skilled in the art that the present disclosure is not limited to the above-described embodiment, and various other embodiments are possible within the scope of the present disclosure.

For example, in the above embodiment, the second registration termination switch is the switch 14B provided on the steering wheel 23. However, the second registration termination switch may include a switch 62B that is operated by voice command input to a microphone 62 connected to the meter ECU 60, as shown in FIG. 1. In this case, when the registration of the leaving route of the vehicle 102 starts, the driver may be notified that the switch 62B serving as one of the second registration termination switches can be operated.

When the second registration termination switch includes the switch 62B operated by voice command, the driver can operate the second registration termination switch by voice command without removing his/her hand from the steering wheel 23.

In the above embodiment, the second registration start switch is a steering switch 14A provided on the steering wheel 23. However, the second registration start switch may include a switch 62A that is operated by voice command input to the microphone 62 connected to the meter ECU 60, as shown in FIG. 1.

When the second registration start switch includes the switch 62A that is operated by voice command, the driver can operate the second registration start switch by voice command without removing his/her hand from the steering wheel 23.

In the above embodiment, in step S60, when it is determined that the second registration termination switch 14B, which is a steering switch, has not been operated by the driver, in step S70, it is determined whether the vehicle 102 ha traveled a distance equal to or greater than the reference distance. Then, when a negative determination is made, the control returns to step S20, and when an affirmative determination is made, step S80 is executed, thereby completing the registration of the leaving route of the vehicle 102. However, step S60 may be omitted.

What is claimed is:

1. A vehicle leaving assistance device comprising: a surrounding information acquisition device that acquires information about surroundings of a vehicle; and an electronic control unit that is configured to execute registration of a leaving route of the vehicle by storing the leaving route of the vehicle in a storage device when a leaving start switch is operated by a driver in a situation where the vehicle leaves a parking lot and runs by driving operation of the driver, and to terminate the registration of the leaving route of the vehicle when a registration termination switch is operated by the driver, wherein
the registration termination switch includes a switch that can be operated by the driver while the vehicle is running.

2. The vehicle leaving assistance device according to claim 1, wherein the registration termination switch includes a first registration termination switch that can be operated by the driver with his/her hand removed from a steering wheel, and a second registration termination switch that can be operated by the driver without removing his/her hand from the steering wheel while the vehicle is running, and the electronic control unit is configured to enable operation of the second registration termination switch without enabling operation of the first registration termination switch when the vehicle is running, and to enable operation of both the first and second registration termination switches when the vehicle is stopped.

3. The vehicle leaving assistance device according to claim 2, wherein the electronic control unit is configured to start registration of the leaving route of the vehicle and to notify the driver that the second registration termination switch can be operated when the registration start switch is operated by the driver.

4. The vehicle leaving assistance device according to claim 2, wherein the first registration termination switch is a soft switch displayed on a display device that is visible to the driver, and the second registration termination switch is a switch provided on the steering wheel.

5. The vehicle leaving assistance device according to claim 2, wherein the first registration termination switch is a soft switch displayed on a display device that is visible to the driver, and the second registration termination switch is a switch operated by a voice command.

6. The vehicle leaving assistance device according to claim 4, wherein the electronic control unit is configured not to display the soft switch on the display device in a state operable by the driver while the vehicle is running after starting the registration of the leaving route of the vehicle.

7. The vehicle leaving assistance device according to claim 4, wherein the electronic control unit is configured to display the soft switch on the display device when the vehicle is stopped after starting the registration of the leaving route of the vehicle.

8. The vehicle leaving assistance device according to claim 2, wherein the electronic control unit is configured to terminate the registration of the leaving route of the vehicle even though the second registration termination switch is not operated by the driver when the electronic control unit determines that the vehicle has traveled a distance equal to or greater than a reference distance without stopping after starting the registration of the leaving route of the vehicle.

9. The vehicle leaving assistance device according to claim 1, wherein the registration start switch includes a first registration start switch that is operated by the driver with his/her hand removed from the steering wheel, and a second registration start switch that can be operated by the driver without removing his/her hand from the steering wheel, and the electronic control unit is configured to enable operation of at least one of the first and second registration start switches while the vehicle is stopped.

10. The vehicle leaving assistance device according to claim 9, wherein the first registration start switch is a soft switch displayed on a display device that is visible to the driver, and the second registration start switch is a switch provided on the steering wheel.

11. The vehicle leaving assistance device according to claim 9, wherein the first registration start switch is a soft switch displayed on a display device that is visible to the driver, and the second registration start switch is a switch operated by a voice command.
